(19) United States
(12) Patent Application Publication
(10) Pub. No.: US 2025/0227497 A1
(43) Pub. Date: Jul. 10, 2025

(54) UE AUTONOMOUS ACTIONS BASED ON ML MODEL FAILURE DETECTION

(71) Applicant: TELEFONAKTIEBOLAGET LM ERICSSON (PUBL), STOCKHOLM (SE)

(72) Inventors: Jingya Li, Göteborg (SE); Mårten Sundberg, Stockholm (SE); Daniel Chen Larsson, Lund (SE); Adrian Garcia Rodriguez, Massy (FR); Emil Ringh, Stockholm (SE); Icaro Leonardo Da Silva, Stockholm (SE)

(21) Appl. No.: 18/853,038

(22) PCT Filed: Mar. 29, 2023
(86) PCT No.: PCT/IB2023/053149

§ 371 Date: Sep. 30, 2024

Related U.S. Application Data
(60) Provisional application No. 63/325,064, filed on Mar. 29, 2022.

(51) Int. Cl. H04W 24/02; H04L 43/0817; H04W 24/10

(52) U.S. Cl. CPC H04W 24/02; H04L 43/0817; H04W 24/10

(57) ABSTRACT

Methods and systems are described for a user equipment (UE) to monitor, detect problems or failures, and perform resolution actions in a machine learning (ML) model. Configurations or parameters for the monitoring, detecting, and/or resolving can be provided by a network node. The UE can perform one or more resolution actions that can be said to be autonomous actions, as they are triggered by the detection of the ML model problem, not in response to a network command or message received after the ML model problem is detected.

### CROSS REFERENCE TO RELATED INFORMATION

This application claims the benefit of United States of America priority application No. 63/325,064 filed on Mar. 29, 2022, titled “UE Autonomous Action Based on ML model Performance.”

### TECHNICAL FIELD

The present disclosure generally relates to the technical field of wireless communications and more particularly to machine learning model monitoring.

### BACKGROUND

Artificial Intelligence (AI), Machine Learning (ML) have been investigated as promising tools to optimize the design of air-interface in wireless communication networks in both academia and industry. Example use cases include using autoencoders for CSI compression to reduce the feedback overhead and improve channel prediction accuracy; using deep neural networks for classifying LOS and NLOS conditions to enhance the positioning accuracy; and using reinforcement learning for beam selection at the network side and/or the UE side to reduce the signaling overhead and beam alignment latency; using deep reinforcement learning to learn an optimal precoding policy for complex MIMO precoding problems.

In 3GPP NR standardization work, there will be a new release 18 study item on AI/ML for NR air interface starting in May 2022. This study item will explore the benefits of augmenting the air-interface with features enabling improved support of AI/ML based algorithms for enhanced performance and/or reduced complexity/overhead. Through studying a few selected use cases (CSI feedback, beam management and positioning), this SI aims at laying the foundation for future air-interface use cases leveraging AI/ML techniques.

When applying AI/ML on air-interference use cases, different levels of collaboration between network nodes and UEs can be considered:
No collaboration between network nodes and UEs. In this case, a proprietary AI/ML model operating with the existing standard air-interface is applied at one end of the communication chain (e.g., at the UE side). And the model life cycle management (e.g., model selection/training, model monitoring, model retraining, model update) is done at this node without inter-node assistance (e.g., assistance information provided by the network node).
Limited collaboration between network nodes and UEs. In this case, an AI/ML model is operating at one end of the communication chain (e.g., at the UE side), but this node gets assistance from the node(s) at the other end of the communication chain (e.g., a gNB) for its AI/ML model life cycle management (e.g., for training/retraining the AI/ML model, model update).
Joint AI/ML operation between network notes and UEs. In this case, it is assumed that the AI/ML model is split with one part located at the network side and the other part located at the UE side. Hence, the AI/ML model requires joint training between the network and UE, and the AI/ML model life cycle management involves both ends of a communication chain.

Here, AI/ML use cases are considered that fall into the category of limited collaboration between network nodes and UEs. It is assumed that a proprietary AI/ML model operating with the existing standard air-interface is placed at the UE side. The AI/ML model output is reported from the UE to the network. Based on this model output, the network takes an action(s) that affect(s) the current or/and subsequent wireless communications between the network and the UE.

As an example, a ML-based CQI (channel quality indicator) report algorithm is deployed at a UE. The UE uses this ML model to estimate the CQI values and report them to its serving gNB. Based on the received CQI report, the gNB performs link-adaptation, beam selection, or/and scheduling decisions for the next data transmission/reception to/from this UE.

Building an AI/ML model includes several development steps where the actual training of the AI model is just one step in a training pipeline. An important part in AI/ML developing is the AI/ML model lifecycle management. This is illustrated in FIG. 1. The AI model lifecycle management typically comprises:
A training (re-training) pipeline:
   a. With data ingestion referring to gathering raw (training) data from a data storage. After data ingestion, there may also be a step that controls the validity of the gathered data.
   b. With data pre-processing referring to some feature engineering applied to the gathered data, e.g., it may include data normalization and possibly a data transformation required for the input data to the AI/ML model.
   c. With the actual model training steps as previously outlined.
   d. With model evaluation referring to benchmarking the performance to some baseline. The iterative steps of model training and model evaluation continues until the acceptable level of performance (as previously exemplified) is achieved.
   e. With model registration referring to register the AI/ML model, including any corresponding AI/ML-meta data that provides information on how the AI/ML model was developed, and possibly AI/ML model evaluation performance outcomes.
A deployment stage to make the trained (or re-trained) AI/ML model part of the inference pipeline.
An inference pipeline:
   a. With data ingestion referring to gathering raw (inference) data from a data storage.
   b. With data pre-processing stage that is typically identical to corresponding processing that occurs in the training pipeline.
   c. With model operational referring to using the trained and deployed model in an operational mode.
   d. With data & model monitoring referring to validating that the inference data are from a distribution that aligns well with the training data, as well as monitoring model outputs for detecting any performance, or operational, drifts.
A drift detection stage that informs about any drifts in the model operations

There currently exist certain challenges. There can be cases where the ML model deployed at the UE does not generalize to some scenarios, thus, the ML model output (e.g., the estimated CQI values, predicted CSI in one or more sub-bands, predicted beam measurements in the time and/or spatial domain, the estimated UE location) are not correct and/or the error interval is higher than acceptable level(s) and/or the accuracy (or accuracy interval(s)) is not acceptable. As the network performs transmission/reception actions based on the ML model output, incorrect model output(s) can result in wrong decisions being made at the network side, and thereby, affecting the wireless communication performance. For example, based on a wrong beam measurement prediction reported by the UE, the network may activate a Transmission Configuration Information (TCI) state (and/or trigger a beam switching) at the UE which does not correspond to a beam the UE is able to detect (or has poor coverage performance); the wrong decisions may lead to Beam Failure Detections (BFD) and/or Beam Failure Recovery (BFR) and/or poor throughput and/or too much signaling due to sub-sequence CSI measurement configuration(s)/activations.

The current NR standard does not define the UE mechanisms to detect a problem related to one or more ML models, e.g., poor ML model performance, or UE actions in case a problem in an ML model is detected.

### SUMMARY

One embodiment under the present disclosure comprises a method performed by a UE for resolving a performance problem in a machine learning model. The method includes detecting one or more performance problems in the machine learning model performed by the UE; and in response to the detecting, performing one or more resolutions actions.

Another embodiment of a method under the present disclosure is a method performed by a network node for configuring a UE to monitor a machine learning model. The method includes transmitting to the UE a configuration indicating the UE to perform detection of a performance problem in a machine learning model.

Another embodiment comprises a method performed by a network node for configuring a UE to monitor a machine learning model. The method includes transmitting to the UE a configuration indicating that the UE is to perform one or more resolution actions.

Another embodiment is a UE for monitoring, detecting problems, or resolving performance in a machine learning model. The UE comprises processing circuitry configured to perform any of the steps of any of the UE-based methods described; and power supply circuitry configured to supply power to the processing circuitry.

Another embodiment is a network node for configuring a UE for monitoring, detecting problems, or resolving performance in a machine learning model. The network node comprises processing circuitry configured to perform any of the steps of any node-based method described herein; and power supply circuitry configured to supply power to the processing circuitry.

Another embodiment is a UE for monitoring, detecting problems, or resolving performance in a machine learning model. The UE comprises an antenna configured to send and receive wireless signals; and radio front-end circuitry connected to the antenna and to processing circuitry, and configured to condition signals communicated between the antenna and the processing circuitry, the processing circuitry being configured to perform any of the steps of any of the UE-based methods described herein. The UE also comprises an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 illustrates the concept of machine learning models;

FIG. 2 shows a flow-chart of a method embodiment under the present disclosure;

FIG. 3 shows a flow-chart of a method embodiment under the present disclosure;

FIG. 4 shows a flow-chart of a method embodiment under the present disclosure;

FIG. 5 shows a flow-chart of a method embodiment under the present disclosure;

FIG. 6 shows a schematic of a communication system embodiment under the present disclosure;

FIG. 7 shows a schematic of a user equipment embodiment under the present disclosure;

FIG. 8 shows a schematic of a network node embodiment under the present disclosure;

FIG. 9 shows a schematic of a host embodiment under the present disclosure;

FIG. 10 shows a schematic of a virtualization environment embodiment under the present disclosure; and

FIG. 11 shows a schematic representation of an embodiment of communication amongst nodes, hosts, and user equipment under the present disclosure.

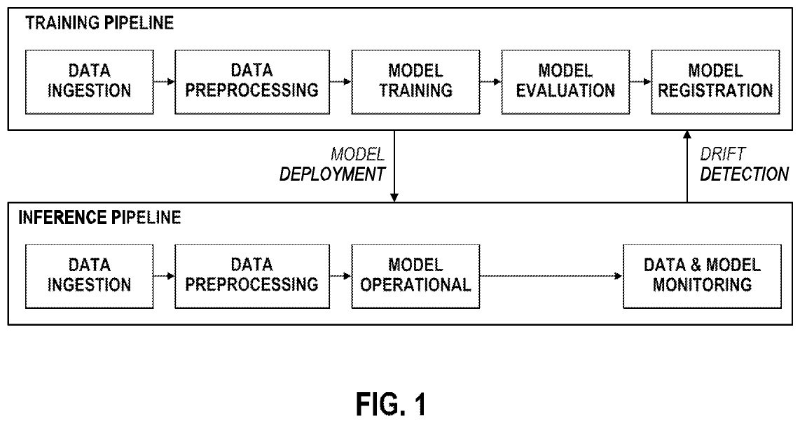

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

Some of the embodiments contemplated herein will now be described more fully with reference to the accompanying drawings. Embodiments are provided by way of example to convey the scope of the subject matter to those skilled in the art. Certain aspects of the disclosure and their embodiments may provide solutions to the challenges identified above or other challenges known in the art. Embodiments under the current disclosure include methods and systems performed by or comprising UEs, network nodes, (e.g., gNodeB, gNodeB-Distributed Unit (gNB-DU), gNodeB-Central Unit (gNB-CU), relay node, a 6G Radio Access Node (RAN), core network node), an Over the Top (OTT) server, and/or other devices or components supporting D2D (device to device) communications.

For purposes of the present disclosure, the terms “ML model” and “AI-model” are interchangeable. An AI/ML model can be defined as a functionality, or be part of a functionality, that is deployed/implemented in a first node (e.g., a UE). The first node (e.g., the UE) can detect that the functionality is not performing correctly or is not acceptable: this may correspond to a prediction error not being acceptable (e.g., prediction error higher than a pre-defined value), error interval is not in acceptable levels, or prediction accuracy is lower than a pre-defined value. Further, an AI/ML model can be defined as a feature or part of a feature that is implemented/supported in a first node. This first node can indicate the feature version to a second node. If the ML model is updated, the feature version maybe changed by the first node.

One aspect of embodiments under the present disclosure includes the UE detecting a performance problem in an ML model, and in response to detecting the performance problem in an ML model, the UE performing one or more resolution actions. The one or more actions can be said to be autonomous actions, as they are triggered by the detection of the ML model problem, not in response to a network command or message received after the ML model problem is detected.

Certain embodiments may provide one or more of the following technical advantages. Certain embodiments can enable the UE to detect an ML model problem, and autonomously resolve the problem, possibly in a transparent manner to the network. Using certain of the embodiments described herein, a problem in an ML model would not cause performance degradation to the communication between the UE and the network node due to outputs from the ML model which has unacceptable or poor performance. Another advantage under certain embodiments is that even if the network is possibly able to assess the ML model performance (e.g., by reception of ML model reports and/or by its own assessment), the network may not be able to re-configure the UE timely, depending on the actual procedure that is affected by the failure of the ML model.

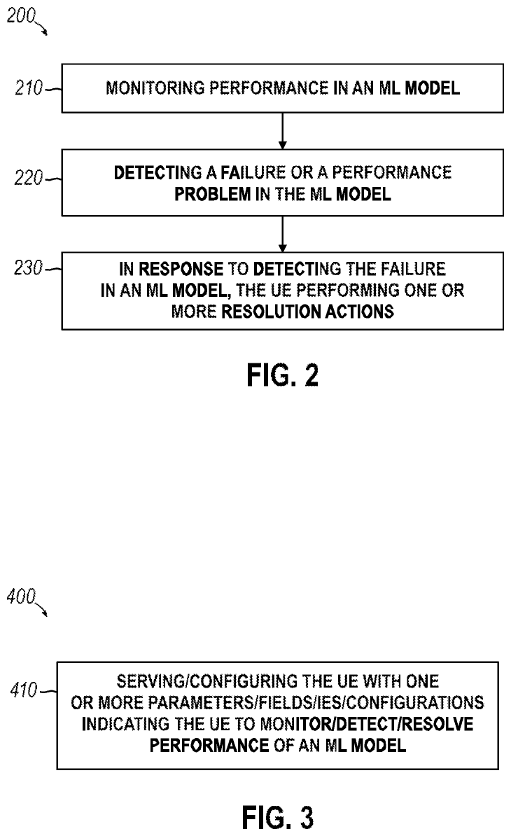

FIG. 2 displays one example method embodiment under the present disclosure. Method 200 is performed by a UE for resolving a performance problem in a ML model. The UE can be operating with at least one ML model (e.g., based on which the UE performs one or more predictions and/or estimates of one or more parameters). Step 210 (optional) is monitoring performance of an ML model. Step 220 is detecting a failure or a performance problem in the ML model. Step 230 is, in response to detecting the failure or performance problem in an ML model, the UE performing one or more resolution actions.

The UE monitoring the performance of the ML model (e.g., step 210) can comprise measuring, calculating, and/or generating one of more values or metrics related to an error or accuracy of the ML model.

The UE detecting a failure in an ML model (e.g., step 220) can comprise the UE monitoring the performance of the ML model and determining that the performance of the model is not acceptable, according to one or more criteria. Thus, the UE is preferably deployed with at least one ML model and monitors the performance of the ML model. The UE detecting a performance problem in an ML model may be based on the configuration of one or more parameters from the network node.

The monitoring or detecting can alternatively comprise the UE determining a performance problem of the ML model at a given time instance or during a time interval, if the performance becomes unacceptable according to one or more criteria. The monitoring or detecting can also comprise the UE determining a recovery from a performance problem of the ML model at a given time instance and/or during a time interval, if the performance becomes acceptable according to one or more criteria.

Examples of the one or more resolution actions (e.g., step 230) can include the following:
UE stops using the ML model;
UE starts (or re-starts) using the classical non-ML-algorithm/function;
UE starts training (or re-training) of the ML model;
UE switches/changes to an ML model which is different than the ML model for which the failure has been detected;
UE activates a second different ML model;
UE deletes (or releases the ML model) using the ML model;
UE resets the ML model;
UE releases (deletes/discards) one or more outputs of the ML model;
UE stops at least one ongoing procedure which uses at least one of the outputs of the ML model;
UE resets at least one protocol layer (or protocol entity) wherein the ML model is being used;
UE initiates an RRC Re-establishment procedure.

Performing one or more resolution actions can also comprise selecting a subset of resolution actions based on a level (or severity) of the ML model problem which has been detected. For example, the ML model problem may be very serious, serious, not-serious, and depending on the outcome, the UE may perform a first subset of the resolution actions, or a second subset of the resolution actions. For example, the RRC Re-establishment procedure might be initiated if the ML model problem is very serious.

One or more of the steps discussed above may be performed by the UE based on one or more configurations. The one or more configurations may have been received from the network, and/or obtained from the UE's own memory e.g., in case a value is hard coded in 3GPP specifications.

FIG. 3 displays another possible method embodiment under the present disclosure. Method 400 is a method performed by a network node for serving or configuring a UE to monitor, detect, and/or resolve an ML model. Step 410 is serving or configuring the UE with one or more parameters/fields/IEs (information element) for any of the actions described in FIG. 2 (and as further described below), such as monitoring, detecting, and resolving ML model performance issues. For example, step 410 can comprise transmitting to the UE a configuration indicating the UE to perform the detection of a performance problem in an ML model. Alternatively, the serving/configuring can comprise transmitting to the UE a configuration indicating that the UE is to perform one or more resolution actions.

### ML Models

An ML model may correspond to a function which receives one or more inputs (e.g., measurements) and provide as outcome one or more predictions or estimates of a certain type. In one example, an ML model may correspond to a function receiving as input the measurement of a reference signal at time instance to (e.g., transmitted in beam-X) and provide as outcome the prediction of the reference signal in timer t₀+T. In another example, an ML model may correspond to a function receiving as input the measurement of a reference signal X (e.g., transmitted in beam-x), such as an SSB (Synchronization Signal Block) whose index is ‘x’, and provide as outcome the prediction of other reference signals transmitted in different beams e.g., reference signal Y (e.g., transmitted in beam-x), such as an SSB whose index is ‘y’. Another example is a ML model for aid in CSI (Channel State Information) estimation. In such a setup the ML model will be a specific ML model with a UE and an ML model within the NW (network) side. Jointly both ML models provide a joint network. The function of the ML model at the UE would be to compress a channel input and the function of the ML model at the NW side would be to decompress the received output from the UE. It is further possible to apply something similar for positioning wherein the input may be a channel impulse in some form related to a certain reference point in time. The purpose on the NW side could be to detect different peaks within the impulse response, that corresponds to different reception directions of radio signals at the UE side. For positioning, another way is to input multiple sets of measurements into an ML network and based on that derive an estimated positioning. Another ML model would be an ML model able to aid the UE in channel estimation or interference estimation for channel estimation. The channel estimation could for example be for the PDSCH (Physical Downlink Shared Channel) and be associated with specific set of reference signals patterns that are transmitted from the NW to the UE. The ML model will then be part of the receiver chain within the UE and may not be directly visible within the reference signal pattern as such that is configured/scheduled to be used between the NW and UE. Another example of an ML model for CSI estimation is to predict a suitable CQI (Channel Quality Information), PMI (Precoder Matrix Indicator), RI (Resource Information) or similar value into the future. The future may be a certain number of slots after the UE has performed the last measurement or targeting a specific slot in time within the future.

The architecture of an ML model (e.g., structure, number of layers, nodes per layer, activation function etc.) may need to be tailored for each particular use case. For example, properties of the data (e.g., CSI-RS (CSI Reference Signal) channel estimates), the channel size, uplink feedback rate, and hardware limitations of the encoder and decoder may all need to be considered when designing the ML model's architecture.

After the ML model's architecture is fixed, it should be trained on one or more datasets. To achieve good performance during live operation in a network (the so-called inference phase), the training datasets should be representative of the actual data the ML model will encounter during live operation in the network.

The training process often involves numerically tuning the ML model's trainable parameters (e.g., the weights and biases of the underlying NN (neural network)) to minimize a loss function on the training datasets. The loss function may be, for example, the Mean Squared Error (MSE) loss calculated as the average of the squared error between the UE's downlink channel estimate H and the network's reconstruction Ĥ, i.e., ∥H−Ĥ∥². The purpose of the loss function is to meaningfully quantify the reconstruction error for the particular use case at hand.

The training process is typically based on some variant of the gradient descent algorithm, which, at its core, comprises three components: a feedforward step, a back propagation step, and a parameter optimization step. These steps can be illustrated using a dense ML model (i.e., a dense NN with a bottleneck layer) as an example.

Feedforward: A batch of training data, such as a mini-batch, (e.g., several downlink-channel estimates) is pushed through the ML model, from the input to the output. The loss function is used to compute the reconstruction loss for all training samples in the batch. The reconstruction loss may be an average reconstruction loss for all training samples in the batch.

The feedforward calculations of a dense ML model with N layers (n=1, 2, . . . . N) may be written as follows: The output vector a″ of layer n is computed from the output of the previous layer a^{[n-1]} using the equations:

z^{[n]}=W^{[n]}·a^{[n-1]}+b^{[n]},a^{[n]}=g(z^{[n]}).

In the above equation W^{[n]} and b^{[n]} are the trainable weights and biases of layer n, respectively, and g is an activation function applied elementwise (for example, a rectified linear unit).

Back propagation (BP): The gradients (partial derivatives of the loss function, L, with respect to each trainable parameter in the ML model) are computed. The back propagation algorithm sequentially works backwards from the ML model output, layer-by-layer, back through the ML model to the input. The back propagation algorithm is built around the chain rule for differentiation: When computing the gradients for layer n in the ML model, it uses the gradients for layer n+1.

For a dense ML model with N layers the back propagation calculations for layer n may be expressed with the following well-known equations

$$\frac{\partial L}{\partial {a}^{[ n ]}} = {[ {W}^{[ n + 1 ]} ]}^{T} \cdot \frac{\partial L}{\partial {z}^{[ n + 1 ]}} , \\ \frac{\partial L}{\partial {z}^{[ n ]}} = \frac{\partial L}{\partial {a}^{[ n ]}} * {g}^{{[ n ]}^{′}} ( {z}^{[ n ]} ) , \\ \frac{\partial L}{\partial {W}^{[ n ]}} = \frac{\partial L}{\partial {z}^{[ n ]}} \cdot {[ {a}^{[ n - 1 ]} ]}^{T} , \\ \frac{\partial L}{\partial {b}^{[ n ]}} = \frac{\partial L}{\partial {z}^{[ n ]}} ,$$

where * here denotes the Hadamard multiplication of two vectors.

Parameter optimization: The gradients computed in the back propagation step are used to update the ML model's trainable parameters. An approach is to use the gradient descent method with a learning rate hyperparameter (α) that scales the gradients of the weights and biases, as illustrated by the following update equations

$${W}^{[ n ]} = {W}^{[ n ]} - α \cdot \frac{\partial L}{\partial {W}^{[ n ]}} , \\ {b}^{[ n ]} = {b}^{[ n ]} - α \cdot \frac{\partial L}{\partial {b}^{[ n ]}} .$$

One important aspect here is to make small adjustments to each parameter with the aim of reducing the average loss over the (mini) batch. It is common to use special optimizers to update the ML model's trainable parameters using gradient information. The following optimizers are widely used to reduce training time and improving overall performance: adaptive sub-gradient methods (AdaGrad), RMSProp, and adaptive moment estimation (ADAM).

The above process (feedforward, back propagation, parameter optimization) is repeated many times until an acceptable level of performance is achieved on the training dataset. An acceptable level of performance may refer to the ML model achieving a pre-defined average reconstruction error over the training dataset (e.g., normalized MSE (mean squared error) of the reconstruction error over the training dataset is less than, say, 0.1). Alternatively, it may refer to the ML model achieving a pre-defined user data throughput gain with respect to a baseline CSI reporting method (e.g., a MIMO (multiple input multiple output) precoding method is selected, and user throughputs are separately estimated for the baseline and the ML model CSI reporting methods). The above actions use numerical methods (e.g., gradient descent) to optimize the ML model's trainable parameters (e.g., weights and biases). The training process, however, typically involves optimizing many other parameters (e.g., higher-level hyperparameters that define the model or the training process). Some example hyperparameters are as follows:
The architecture of the ML model (e.g., dense, convolutional, transformer);
Architecture-specific parameters (e.g., the number of nodes per layer in a dense network, or the kernel sizes of a convolutional network);
The depth or size of the ML model (e.g., number of layers);
The activation functions used at each node within the ML model;

The mini-batch size (e.g., the number of channel samples fed into each iteration of the above training steps);
The learning rate for gradient descent and/or the optimizer; and
The regularization method (e.g., weight regularization or dropout).

Additional validation datasets may be used to tune the ML model's architecture and other hyperparameters.

### UE Monitoring the Performance of the ML Model

The monitoring performed by a UE of a ML model can take a variety of forms and variations. In certain embodiments the UE monitors the performance of the ML model by measuring, calculating, generating, and/or computing one of more of the following values and/or metrics related to an error and/or accuracy of the ML model:
an error (relative and/or absolute) calculated based on one or more outputs of the ML model and the corresponding parameter the ML model tries to estimate and/or predict (an example of absolute error may be the value of the ‘estimate’-value of the ‘parameter’);
an accuracy (relative and/or absolute) calculated based on one or more outputs of the ML model and the corresponding parameter the ML model tries to estimate and/or predict;
a value (or distribution or any representation of the distribution) in percentage that indicates the confidence level of the ML model outcome;
a confidence interval (or any representation of the confidence interval);
statistic info of the data collected within a time window; and/or
at least one key performance indicator indicating the ML model ability, quality, power, or accuracy to estimate as an output a parameter X in comparison to the actual value of the parameter X, or in other words, how accurate the estimate or prediction of parameter X (output of the ML model) is of the actual value of parameter X.

For example, if the ML model is meant to estimate/predict the CSI of a first sub-band in frequency, the key performance indicator indicates the ML model ability, quality, power, or accuracy to estimate as an output the CSI of the first sub-band in frequency (e.g., as defined in TS 38.214) in comparison to the actual value (measured) of the CSI of the first sub-band in frequency. Or in other words, how accurate the estimate or prediction of the CSI of the first sub-band in frequency (output of the ML model) is of the actual value of the CSI of the first sub-band in frequency.

For another example, if the ML model is meant to estimate/predict a measurement, such as Reference Signal Received Power (RSRP) of a Reference Signal, e.g. CSI-RS, Synchronization Signal (SS) or SS/PBCH (Physical Broadcast Channel) block (SSB), as defined in 3GPP TS 38.211, 3GPP TS 38.300, 3GPP TS 38.215, the key performance indicator indicates the ML model ability, quality, power, or accuracy to estimate as an output the RSRP in time t₀+T in comparison to the actual value (measured) of the RSRP at time t₀+T. Or in other words, how accurate the estimate or prediction of the RSRP (output of the ML model) is of the actual value of the RSRP.

In a set of embodiments, the values and/or metrics related to an error and/or accuracy of the ML model are configured by the network, or obtained by the UE via other means (e.g., from its memory, in case it is hard coded, or if a single metric is specified by 3GPP). In other embodiments, the values and/or metrics related to an error and/or accuracy of the ML model the UE is capable of measuring or calculating are associated to a capability which the UE reports to the network. Upon reception the network configures the ML model performance monitoring at the UE with the one or more errors and/or accuracies of the ML model. In certain embodiments, the UE monitors the performance of the ML model by measuring or calculating a metric and comparing that to a reference value of that metric associated to a performance indicator of the radio link quality, wherein the performance indicator of the radio link quality may also have its own reference value associated to an acceptable level (or unacceptable level) of the performance indicator of the radio link quality.

In one embodiment, the UE measures the error of the ML model (e.g., UE measures the error is X %) and compares to the reference value of the error e.g., 10%. The reference value of the ML model error can be associated to a performance indicator of the radio link quality, such as a Block Error Rate (BLER), which may also have a reference value (e.g., 5%). Then, the UE compares (or checks, or evaluates) if the measured error of X % is higher (>) than the reference value (of 10%); and if it is, it assumes that the BLER is higher than 5% (hypothetical BLER), which may be considered unacceptable. In other words, this means that if the ML model provides as output an estimate or prediction which is far from the actual value (which would have been measured) and the network or the UE would have taken decisions based on the ML model outputs, the radio link would perform worse than an acceptable level. For example, if it is assumed that the ML model is producing as output one or more predictions of Layer 1 (L1) RSRP of SSB(s) and the UE is monitoring PDCCH (Physical Downlink Control Channel) based on these predictions (e.g., based on activated TCI (Transmission Configuration Indicator) states), if X %>10%, the BLER would have been higher than 5% (hypothetical BLER), which may be considered unacceptable.

In other embodiments, the UE monitors the performance of the ML model by measuring or calculating a metric and comparing that to a reference value of that metric associated to a performance indicator of the feature associated to the ML model, wherein the performance indicator of the feature associated to the ML model may also have its own reference value associated to an acceptable level (or unacceptable level) of the performance indicator of the feature associated to the ML model.

In other variations, the UE starts to monitor the performance of the ML model when the UE transitions to RRC_CONNECTED (Radio Resource Control Connected). And the UE performs the monitoring of the performance of the ML model while it is in RRC_CONNECTED.

In certain variations, the UE stops monitoring the performance of the ML model when it transitions to RRC_IDLE (e.g., upon reception of an RRC Release message) or RRC_INACTIVE (e.g., upon reception of an RRC Release message including a suspend configuration). This makes sense if the ML model outputs are meant to be used as input to features while the UE is in RRC_CONNECTED, such as CSI reporting and beam management.

Certain embodiments can include a ML model problem (MLMP) indication. Here, the UE may monitor the performance of the ML model and, if the performance of the ML model at a given time instance or time interval becomes worse than acceptable (e.g., according to a value, threshold, etc.), the UE generates or triggers a first event or indication e.g., ML model problem (MLMP) indication. A series of MLMP indications within a specified time interval may be a failure indication (as discussed further below).

Certain embodiments can include a ML model recovery (MLMR) indication. Here, the UE monitors the performance of the ML model and, if the performance of the ML model at a given time instance or time interval becomes better than unacceptable (e.g., according to a value, threshold, etc.), the UE generates or triggers a second event or indication e.g., ML model recovery (MLMR) indication. A series of MLMR indications within a specified time interval may be a failure indication (as discussed further below).

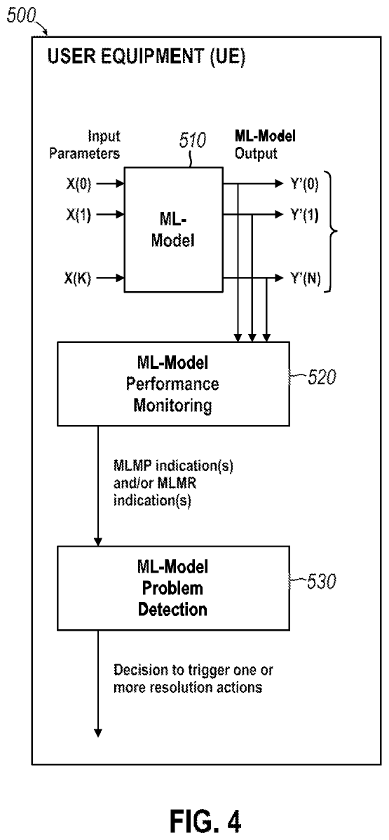

FIG. 4 shows a schematic diagram of how possible input parameters and ML model outputs interact or result from the ML model, and get fed to ML model performance monitoring. System 500 comprises an ML model 510 receiving input parameters x(0), x(1) . . . x(K), and yielding outputs y′(0), y′(1) . . . y′(N). These outputs are received by the ML model performance monitoring function 520, which may output MLMP indications or MLMR indications to a ML model problem detection function 530. This can trigger a decision to perform one or more resolution actions.

Monitoring of ML models can also be periodic or aperiodic, as described in more detail below.

### Periodic ML Model Performance Monitoring

In some embodiments the UE performs the monitoring of the ML model performance periodically, according to an assessment period (or monitoring period or periodicity).

In certain embodiments the assessment periodicity (or monitoring period) is configured by the network to the UE, or hard coded at the UE (i.e., the UE is aware of it without the need to be explicitly configured by the network).

In other embodiments the assessment periodicity (or monitoring period) is derived by the UE based on one or more parameters such as carrier frequency, subcarrier spacing, the usage of DRX (discontinuous reception) or not, periodicity configurations of one or more reference signals, e.g., SSB, etc.

In some embodiments the configuration of the periodic monitoring of the ML-performance at the UE may be received in (or obtained) an RRC message received by the UE in a signaling radio bearer, e.g., SRB1 (Signalling Radio Bearer One), configured at the UE, or/and in an ML-feature specific RRC signaling and/or in an IE defined in RRC. Upon reception of the configuration, the UE performs ML model performance monitoring.

In some embodiments, the following parameters may determine how the UE performs the monitoring of the ML model performance (wherein this may possibly be configured by the network):
The ML model(s) and/or ML features to monitor the performance periodically.
If the ML model performance monitoring is performed across multiple serving cells or only within the current serving cell, wherein this may be modeled by including the configuration in each serving cell configuration (e.g., in the IE ServingCellConfig, in a series of nested IEs). Alternatively, within a certain paging area or across different paging areas.
Time window for the ML model performance monitoring.
If the ML model performance monitoring is to be stopped or suspended by the UE when the UE transitions to RRC IDLE and/or RRC INACTIVE STATE from RRC_CONNECTED STATE, or if the ML model performance monitoring is to be maintained by the UE (e.g., for later reporting when the UE transitions to RRC_CONNECTED).
If the ML model performance monitoring is performed both in DRX and non-DRX operation by the UE. It could be so that the performance of the ML model is only monitored in non-DRX when the report is possible to be sent by the UE.
If the monitoring of the ML model performance is stopped when UL timing alignment is lost. That is when the UE has lost UL synchronization. That could for example be determined by the expiry of the timeAlignmentTimer. Alternatively, the performance monitoring may continue if an event is triggered. In such cases, the UE will try to achieve UL synchronization and, subsequently, transmit the associated report.
Information about the periodicity and time domain offset (e.g., time slot) based on which the UE derives which time domain resources are allowed to be used for monitoring the performance of the ML model.

In some embodiments, the configuration of the periodic ML model performance is done by both RRC, MAC CE (Medium Access Control Control Element) or L1 (layer 1) signaling. The configuration as such is setup by RRC signaling but can be activated/deactivated by either a later second RRC message, MAC CE or L1 signaling from the NW to the UE. The L1 signaling can for example be a Downlink Control Information (DCI) format. After the UE receives such a message, the UE will start the periodic ML model performance monitoring. The UE may further stop the reporting after receiving a third message by RRC, MAC CE or L1 indicating that the reporting should stop.

### Aperiodic/Event-Based Monitoring

In alternatives to periodic-based monitoring, some embodiments can utilize aperiodic or event-based monitoring.

In some embodiments, the UE is requested by the network node to perform an aperiodic monitoring of the ML model (e.g., without a dependence on the occurrence of a certain event or condition). Based on receiving the request for an aperiodic ML model performance (e.g., a DCI and/or MAC CE received after the UE has been configured with the configuration for the aperiodic monitoring of ML model performance), the UE starts performing the monitoring of the ML model performance.

Prior to the UE being requested by the NW to perform the aperiodic monitoring of the ML model performance, the NW may have configured the UE with one or more configurations related to the aperiodic ML model performance. The one or more configurations related to the aperiodic ML model performance monitoring may be received by (or obtained by) the UE in an RRC message received in a signaling radio bearer, e.g., SRB1, configured at the UE and/or in an IE defined in an RRC. Upon reception of the configuration, the UE performs the monitoring of the ML model performance in case it is at a later point requested by the network to act on it e.g., start to use as input for failure detection and/or for failure recovery. The UE starts performing the ML model performance monitoring according to the configuration received if it later receives another indication (e.g., DCI) that it needs to perform the ML model performance monitoring.

In some embodiments, the following parameters may determine how the UE performs the monitoring of the ML model performance (wherein this may possibly be configured by the network):
The ML model(s) and/or ML features to monitor the performance.
If the ML model performance monitoring is performed across multiple serving cells or only within the current serving cell, wherein this may be modeled by including the configuration in each serving cell configuration (e.g., in the IE ServingCellConfig, in a series of nested IEs). Alternatively, within a certain paging area or across different paging areas.
Time window for the ML model performance monitoring (e.g., starting window, duration and/or offset in terms of number of time domain units such as frames, subframes, slots, and symbols).
If the ML model performance monitoring is to be stopped or suspended by the UE when the UE transitions to RRC IDLE and/or RRC INACTIVE STATE from RRC_CONNECTED STATE, or if the ML model performance monitoring is to be maintained by the UE (e.g., for later reporting when the UE transitions to RRC_CONNECTED).
If the ML model performance monitoring is performed both in DRX and non-DRX operation by the UE. It could be so that the performance of the ML model is only monitored in non-DRX when the report is possible to be sent by the UE.
If the monitoring of the ML model performance is stopped when UL timing alignment is lost. That is when the UE has lost UL synchronization. That could for example be determined by the expiry of the timeAlignmentTimer. Alternatively, the performance monitoring may continue if an event is triggered. In such cases, the UE will try to achieve UL synchronization and, subsequently, transmit the associated report.

The NW can trigger/request an aperiodic ML-performance monitoring to the UE with an RRC message, MAC CE or L1 signaling. The L1 signaling can for example be a DCI format. If the request/trigger is performed via an RRC message, the configuration of the aperiodic ML model performance may be directly included in the trigger/request message from the NW.

The NW trigger/request message (e.g., MAC CE, RRC or L1 signaling) preferably includes at least one indication or reference of one or more of the following:
Which ML model(s) and/or ML features to monitor.
Aperiodic ML model monitoring ID, according to the above RRC configuration message, indicating what is to be monitored in terms of ML model performance monitoring.
Information on which resources in time, frequency, and code domain the periodic ML model performance is to be monitored, such as the exact resources available to be measured for the purpose of ML model performance monitoring. For example, this information may specify the resource blocks, slot/subframe, the symbols in time, and/or the type of code (e.g., spreading code or orthogonal code) for the reference signals, such as SSBs and/or CSI-RS which are to be measured when the UE needs to perform the ML model performance monitoring. In the time domain, time instances for the monitoring may correspond to one or more slot(s), symbol(s), subframe(s) or SFN(s).

### UE Detecting a Failure in an ML Model

Referring back to FIG. 2, step 220 is detecting a failure or a performance problem in the ML model. This detecting can take a variety of forms and can comprise multiple variations.

In various embodiments the UE can detect a failure in an ML model based on the UE monitoring the performance of the ML model. For example, the ML model performance problem can be detected if the performance becomes worse than an acceptable level (or suitability level), according to one or more criteria. Thus, the UE can be deployed with at least one ML model and monitor the performance of the ML model. The UE detecting a performance problem in an ML model may be based on the configuration of one or more parameters from the network node (or based on parameters which are known to the UE e.g., hard coded).

In certain embodiments, the UE detects a failure in the ML model based on one or more indications from the monitoring of the ML-performance model. The one or more indications may be calculated, detected, and/or measured according to one of the methods disclosed above regarding the monitoring of step 210 of FIG. 2. For example, an indication may be the MLMP indication. In one example, a single ML-performance model problem may be considered as a failure in the ML model, so the one or more resolution actions may be triggered.

Several types of embodiments of detecting a failure or performance problem include: a failure counter; a failure timer; failure counter and failure timer; recovery counter; failure timer b; failure timer b and failure counter; failure timer b, failure counter and recovery counter.

### Failure Counter

There can also be embodiments based on a failure counter. In one set of embodiments, the UE is configured with a failure counter maximum value (failure_max_count) so that the UE detects a failure in the ML model if the number of ML model problems reaches the failure counter maximum value. The UE monitors each instance that a ML model problem occurs and increments the failure counter, and if the failure counter reaches the failure counter maximum value the ML model failure is detected. Certain embodiments with a failure counter can include:
In one embodiment, an ML model performance monitoring function is responsible for detecting ML model performance problems. And, upon the occurrence of a ML model performance problem, such as the generation of a MLMP indication, the failure counter is incremented.
In one embodiment, the failure counter is set to zero (0) when the UE starts the ML model performance monitoring.
This may be some kind of filtering, to prevent the UE to consider the ML model as failed based on too few problem occurrences. That could be dependent on the resolution actions the UE takes.

### Failure Timer

There can also be embodiments based on a failure timer. In one set of embodiments, the UE is configured with a failure timer value, wherein the UE detects the failure of the ML model if the failure occurs for that time value. This means that the UE does perform a recovery action if a failure or problem in the ML model occurs in sparse time instances i.e., these would preferably occur within a relatively short time.

### Failure Timer and Failure Counter

There can also be embodiments based both on failure timer and failure counter. In one set of embodiments, the UE receives a failure timer value and a failure counter maximum value. When the UE detects an ML model problem (e.g., indication internally at the UE of a MLMP, or any other criterion according to the various embodiments of monitoring discussed above, the UE starts the failure timer and increments the failure counter. If the number of instances reaches the failure counter maximum value while the failure timer is running, the UE declares a failure in the ML model and performs the one or more recovery actions (various recovery action embodiments discussed below). If the timer expires (i.e., before the number of ML model problem or problem instances (or MLMP indication(s)) reaches the failure counter maximum value), the UE resets the failure counter. The advantage of using the counter and the timer is that the UE does not need to take recovery actions if ML model performance problems are sparse in time and/or there are only a few problems, especially if the recovery action(s) requires a disruption in data transmission/reception, such as the reset of one or more protocol entities and/or signaling exchange with the network.

### Recovery Counter

There can also be embodiments based on a recovery counter. In one set of embodiments, the UE is configured with a recovery counter value so that the UE detects a recovery of the ML model if the number of ML model recoveries reaches the recovery counter value. The UE monitors each instance that a ML model recovery occurs and increments the recovery counter, and if the recovery counter reaches the recovery counter value the ML model recovery is detected.
In one embodiment, a ML model performance monitoring function is responsible for detecting ML model performance recoveries. And, upon the occurrence of a ML model performance recovery (e.g., according to embodiments of monitoring discussed above), such as the generation of a MLMR indication, the recovery counter is incremented.
In one embodiment, the recovery counter is set to zero (0) when the UE starts the ML model performance monitoring.
This may be some kind of filtering, to prevent the UE to consider the ML model as recovered based on too few recovery occurrences.

### Failure Timer b

There can also be embodiments based on a failure timer b. In one set of embodiments, the UE is configured with a failure timer value for a failure timer b, wherein the UE detects the failure of the ML model if the failure timer b expires.

### Failure Timer b and Failure Counter

There can also be embodiments based both on a failure timer b and a failure counter. In one set of embodiments, the UE receives a failure timer value b and a failure counter maximum value. When the UE detects an ML model problem (e.g., indication internally at the UE of a MLMP, or any other criterion according to the monitoring embodiments discussed above, the UE increments the failure counter and, if the number of instances reaches the failure counter maximum value the failure timer is started.

### Failure Timer b, Failure Counter, and Recovery Counter

There can also be embodiments based on all three of failure timer b, failure counter and recovery counter. In one set of embodiments, when the UE detects an ML model problem (e.g., indication internally at the UE of a MLMP, or any other criterion according to at least the various monitoring embodiments discussed above), the UE increments the failure counter and, if the number of instances reaches the failure counter maximum value the failure timer b is started. While the failure timer b is running, the UE has an ML model performance recovery indication and increments the recovery counter, and if the recovery counter becomes higher than the recovery counter value, the UE stops the failure timer b, and resets the failure counter. One advantage of using the counter and the timer is that the UE does not need to take recovery actions if ML model performance problems are sparse in time and/or there are only a few problems, especially if the recovery action(s) requires a disruption in data transmission/reception, such as the reset of one or more protocol entities and/or signaling exchange with the network.

In some embodiments, the failure counter maximum value and/or failure timer value(s) are part of an ML model failure detection configuration, which the UE possibly has received from the network. Such configurations may be configured, e.g., i) per serving cell (e.g., PSCell (primary secondary cell) configuration, SCell (secondary cell) configuration); ii) per cell group (e.g., MCG (Master Cell Group), SCG (Secondary Cell Group)); iii) per ML model.

In certain embodiments, the performance monitoring of the ML model (and the ML model problem detection) is performed at the lower layers e.g., at the L1 of the UE, and the monitoring of the failure counter and failure timer is performed at the higher layers e.g., MAC layer or RRC layer (or any other layer responsible for the failure detection).

### UE Performing One or More Resolution Actions

Referring again to FIG. 2, step 230 includes, in response to detecting a failure or performance problem, performing one or more resolution actions. The performing one or more resolution actions can take a variety of embodiments and may correspond to one or more of the following options.

In some embodiments, the UE stops (or suspends) the monitoring of ML model performance. In some embodiments the UE stops using the ML model. The UE stopping use of the ML model can comprise: the UE not performing predictions/estimations based on the one or more ML model(s) and/or not producing outputs from the one or more ML models(s) and/or not reporting outputs from the one or more ML models(s) and/or stops using the predictions/estimations based on the one or more ML model(s) as input to a function leading to a UE action.

In some embodiments the UE starts (or re-starts) using the classical non-ML-algorithm/function. This can take a variety of forms. In some examples, the UE starting (or re-starts or continues) using the classical non-ML-algorithm/function comprises the UE performing measurements (e.g., CSI measurements, RSRP, RSRQ and/or SINR measurements) not based on the one or more ML model outputs (wherein the ML model is the model for which the one or more indications of the ML model performance has/have been reported). In some examples, UE starting (or re-starts or continues) using the classical non-ML-algorithm/function comprises the UE using a reporting mode (e.g., CSI report) not based on the one or more ML model outputs (wherein the ML model is the model for which the one or more indications of the ML model performance has/have been reported). In some examples, the way the UE uses the classical non-ML-algorithm/function may be controlled by one or more parameters the UE has received from the network before the ML model failure has been detected. In this context, a classical non-ML algorithm/function may correspond to the UE performing one or more measurements instead of predictions, or the UE not performing predictions. A classical non-ML algorithm/function refers to the fact that the legacy UEs would operate according to these types of algorithms/functions, based on measurements instead of predictions. For example, if the UE was performing RSRP predictions for one or more SSBs, the UE start/restart using the classical non-ML algorithm/function comprises the UE stopping performing these RSRP predictions and performing actual RSRP measurements. For the outputs of the ML model e.g., Y′(0), . . . , Y′(N) there may be one or more parameters Y(0), . . . , Y(Nx) based on conventional non-ML model algorithms/functions. For example, if the ML model produces as outputs one or more predictions/estimates of CSI for CSI reporting, the UE transmits the actual CSI (either instead or in addition to the estimates). This may be called a fallback procedure, wherein the UE starts (or re-starts) using the classical non-ML-algorithm/function upon detecting the failure of the ML model. The advantage is that if the UE and/or the network relies on the outputs of the model for one or more procedures (e.g. predictions of RSRP for beam management) the procedures may still continue despite the failure of the ML model.

In certain embodiments the UE performs training (or re-training) of the ML model. The training or re-training can take a variety of embodiments. In some examples, the UE performing the training comprises the UE initiating or starting to perform the training. In some examples, the UE performing the training (or re-training) of the ML model comprises the UE obtaining one or more parameters used for the training of the ML model. For example, if the ML model produces CSI estimates/predictions (based on one or more input) for a sub-band X, the UE starts to measure and collect the CSI for sub-band X, to feed the training/re-training function. In some examples, the UE performing the training (or re-training) of the ML model comprises the UE starting a timer T (possibly configured by the network or known to the UE via some other means, e.g., retrieved from memory) and after the timer T expires the UE can re-start the monitoring of the ML model performance. In some situations, the UE starting the training (or re-training) of the ML model comprises the UE collecting a number of measurements (or samples) ‘N’ for the training/re-training, wherein ‘N’ is possibly configured by the network or known to the UE via some other means, e.g., retrieved from memory. After the number of measurements (or samples) the UE re-start the monitoring of the ML model performance. In some examples, the UE starting the training (or re-training) of the ML model comprises the UE performing measurements during a number of measurement periods ‘K’ for the training/re-training, wherein ‘K’ is possibly configured by the network or known to the UE via some other means, e.g., retrieved from memory. After the number of measurements periods the UE re-start the monitoring of the ML model performance.

If after re-training/training the UE re-starts the monitoring of the ML model performance and detects that the ML model performance is recovered (according to any criterion defined above for the monitoring and detecting of failures or performance problems), e.g., if the ML model which had failed starts to have an ML model performance which is acceptable, the UE can perform one or more actions as follows.
Change the status and/or a state variable and/or a state condition from ML model ‘FAILED’ to ML model ‘RECOVERED’;
Consider the ML model to be Recovered or acceptable and operates accordingly;
Start to use the ML model and/or resume the operation of the ML model, e.g., the UE performing predictions/estimations based on the one or more ML models and/or producing outputs from the one or more ML models and/or reporting outputs from the one or more ML models, and/or using the predictions/estimations based on the one or more ML models as input to a function leading to a UE action;
Stop using the classical non-ML-algorithm/function;
Deactivate (or leave) the fallback procedure, in other words, the UE stops using the classical non-ML-algorithm/function upon detecting the recovery of the ML model. One advantage here is that if the UE and/or the network relies on the outputs of the model for one or more procedures (e.g., predictions of RSRP for beam management) and the ML model starts to perform in an acceptable manner, the procedure continues with the ML model outputs.

In other embodiments of performing recovery actions, the UE switches/changes to a second ML model which is different than the ML model for which the failure has been detected (first ML model, failed ML model). In one option, the second ML model is considered to be of the same type as the first ML model (e.g., generates at least one of the outputs produced by the ML model which has failed). In another option, the second ML model is considered to be more basic/limited functionality compared to the first ML model (e.g., generates fewer outputs produced by the ML model which has failed). In a further option the new ML model is a default ML model, to be used in case the ML model fails. In an additional option, the second ML model is used while the ML model re-training is ongoing (e.g., while the timer for re-training disclosed above is running); when the ML model is recovered after re-training, e.g., if performance of the ML model becomes acceptable, the UE switches back to the first ML model. There could be more than two ML models, with different priorities.

In certain embodiments the UE deletes (or releases the ML model). The UE deleting (or releasing the ML model) can comprise the UE releasing one or more parameters, configurations and/or state variables related to the ML model and/or necessary for the ML model operation.

In other embodiments the UE resets the ML model. The UE resetting the ML model can comprise the UE resetting one or more functionalities, stopping timers, resetting counters related to the ML model and/or necessary for the ML model operation.

In other embodiments the UE releases (deletes/discards) one or more outputs of the ML model.

In certain embodiments the UE stops at least one ongoing procedure which uses at least one of the outputs of the ML model. The UE stopping the at least one ongoing procedure which uses at least one of the outputs of the ML model can comprise, e.g., the lower layers (L1 or MAC) indicating that to the higher layers (MAC, or RRC); the higher layers (e.g., RRC or MAC) indicating that to the lower layers (MAC and/or L1).

In other embodiments of recovery actions, the UE resets at least one protocol layer (or protocol entity) wherein the ML model is being used. In one option, if the ML model is used at least partially in the MAC layer, the detection of the failure of the ML model triggers the reset of the MAC entity. In another option, if the ML model is used at least partially in the RLC layer, the detection of the failure of the ML model triggers the reset of the RLC entity. In a further option, if the ML model is used at least partially in the PDCP layer, the detection of the failure of the ML model triggers the reset of the PDCP entity.

In other embodiments, the UE initiates an RRC Re-establishment procedure as a recovery action. For example, the UE can transmit an RRC Reestablishment Request message; that may include a cause value indicating that the procedure is triggered due to the failure of an ML model. In response the UE receives an RRC Reestablishment message and transmits an RRC Reestablishment Complete message.

In other embodiments the UE performing one or more resolution actions can comprise selecting a resolution action depending on a level of the ML model problem which has been detected. For example, the ML model problem may be serious or not-serious, and depending on the outcome the UE performs a first subset of the resolution actions, or a second subset of the resolution actions e.g., RRC Re-establishment is only initiated if the ML model problem is serious.

### Sending and Receiving of Configuration for ML Model Problem Detection and Resolution Actions

Referring to FIG. 3, a network node or other network component can send configurations to a UE for ML model monitoring, problem detection, and/or resolution actions. In addition to the steps illustrated by FIG. 2, an additional step may comprise the UE receiving one or more configurations (e.g., from a network node) for ML model monitoring, problem detection, and/or resolution actions.

Step 410 of FIG. 4 can comprise a network node serving the UE can comprise the network configuring the UE with one or more parameters for any of the actions described above for possible embodiments of monitoring, detecting, and/or performing resolution actions. For example, the network can transmit to the UE (and the UE can receive) a configuration indicating the UE to perform the detection of a performance problem in an ML model. In another example, the network transmits to the UE a configuration indicating that the UE is to perform one or more resolution actions. The network, NW, and/or network node in the embodiments described herein can be, e.g., one of a generic NW node, gNB, base station, unit within the base station to handle at least some ML operation, relay node, core network node, a core network node that handle at least some ML operations, or a device supporting D2D communication.

The messages carrying the one or more configurations can take a variety of forms. In one set of embodiments, the UE receives the configuration for the ML model performance monitoring in one or more of the following RRC messages in these different scenarios:
an RRC Reconfiguration message, received by the UE during the transition from RRC_IDLE to RRC_CONNECTED, or during a handover;
an RRC Setup message received by the UE during the transition from RRC_IDLE to RRC_CONNECTED or during a fallback from RRC_INACTIVE to RRC_IDLE or during re-establishment;
an RRC Resume message, received by the UE during the transition from RRC_INACTIVE to RRC_CONNECTED.
   In all these examples, the UE is meant to perform the monitoring and reporting in RRC_CONNECTED.

In other examples of message embodiments, the UE receives the configuration for the ML model performance monitoring in a message in which the UE transitions to RRC_IDLE or RRC_INACTIVE. When the UE transitions to RRC_IDLE or RRC_INACTIVE the UE starts to perform the monitoring of the ML model performance and, when the UE transitions to RRC_CONNECTED (e.g., upon reception of an RRC resume message) it may be configured to perform periodic report of the ML model performance, which is available at the UE.

Note that even though the certain examples given in the present disclosure focus mainly on the UE reporting aspects over the Uu interface, the same methodologies can be applied for supporting ML model performance monitoring using signaling between different UEs over the PC5 interference. In that case, slidelink related physical signals/channels and configurations can be utilized and enhanced to support the model update related signaling between UEs. Examples of these signals/channels include PC5 connection establishment procedure, sidelink control information (SCI), physical sidelink control channel (PSCCH), physical sidelink shared channel (PSSCH), physical sidelink feedback channel (PSFCH).

### Additional Embodiments

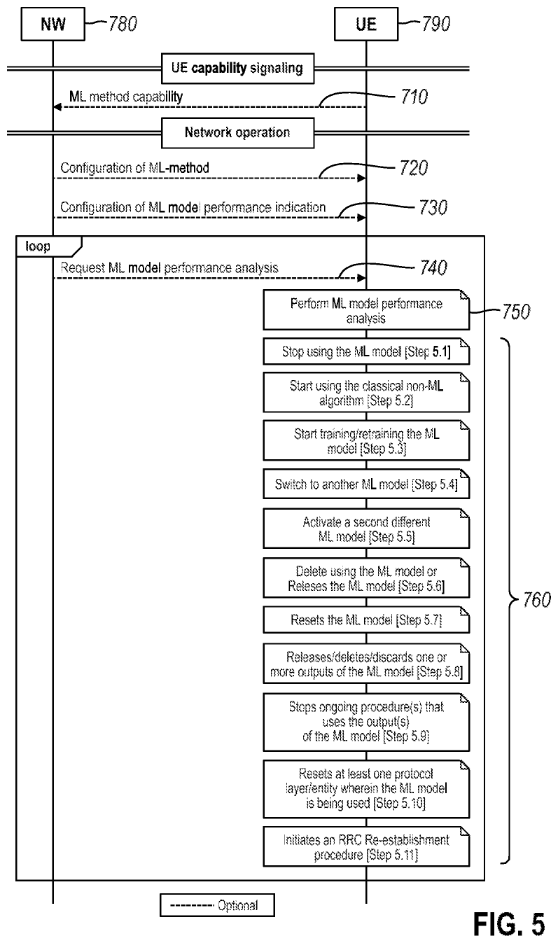

From a system perspective, a method embodiment can include signalling between a NW 780 and a UE 790, such as the flow chart shown in FIG. 5. Method 700 can include the following steps that may be performed in combination or independently. Alternative embodiments of method 700 do not have to include every single step shown. In step 710 (optional), the UE 790 indicates capability of ML model method (including ML model performance analysis). This can include e.g., indicating which exact ML model the UE 790 is capable of; indicating whether the UE 790 is capable of performing the detection of an ML model problem/failure; and/or whether the UE 790 is capable of performing one or more of the resolution actions. In step 720 (optional), an ML model is configured by the NW 780 (alternatively it is applied by default e.g., upon configuration of a feature, such as beam measurements, beam reporting, CSI measurements, etc.). In step 730 (optional), the UE 790 operating with an ML model deployed at the UE 790 is configured. At step 740 (optional), the UE 790 operating with a ML model deployed at the UE 790 is configured by the NW 780 to perform the monitoring of the ML model performance, and/or the detection of ML model performance problem/failure. At step 750, the UE 790 performs the monitoring ML model performance and the detection of ML model performance problem/failure. At step 760, the UE 790 performs one or more of the resolution actions, such as:
stops using the ML model;
starts (or re-starts) using the classical non-ML-algorithm/function;
starts training (or re-training) of the ML model;
switches/changes to an ML model which is different than the ML model for which the failure has been detected;
activates a second different the ML model;
deletes (or releases the ML model) using the ML model;
resets the ML model;
releases (deletes/discards) one or more outputs of the ML model;
stops at least one ongoing procedure which uses at least one of the outputs of the ML model;
resets at least one protocol layer (or protocol entity) wherein the ML model is being used;
initiates an RRC Re-establishment procedure.

FIG. 5 shows an overview of one embodiment of proposed signaling between the NW 780 and a UE 790 for the UE 790 to perform ML model problem detection and resolution actions. The steps 710 to 760 described above can be seen forming messaging/communications from the NW 780 to the UE 790 or vice versa. FIG. 5 further shows where certain functionalities can be performed, for example steps 740 to 760 being performed at the UE.

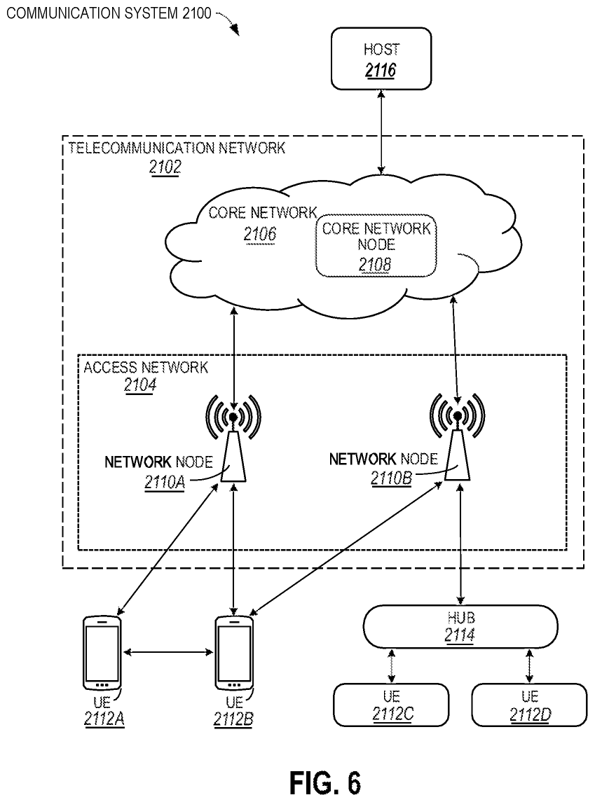

FIG. 6 shows an example of a communication system 2100 in accordance with some embodiments. In the example, the communication system 2100 includes a telecommunication network 2102 that includes an access network 2104, such as a RAN, and a core network 2106, which includes one or more core network nodes 2108. The access network 2104 includes one or more access network nodes, such as network nodes 2110a and 2110b (one or more of which may be generally referred to as network nodes 2110), or any other similar 3rd Generation Partnership Project (3GPP) access node or non-3GPP access point. The network nodes 2110 facilitate direct or indirect connection of UE, such as by connecting UEs 2112a, 2112b, 2112c, and 2112d (one or more of which may be generally referred to as UEs 2112) to the core network 2106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 2100 may include and/or interface with any type of communication, telecommunication, data, cellular, radio network, and/or other similar type of system.

The UEs 2112 may be any of a wide variety of communication devices, including wireless devices arranged, configured, and/or operable to communicate wirelessly with the network nodes 2110 and other communication devices. Similarly, the network nodes 2110 are arranged, capable, configured, and/or operable to communicate directly or indirectly with the UEs 2112 and/or with other network nodes or equipment in the telecommunication network 2102 to enable and/or provide network access, such as wireless network access, and/or to perform other functions, such as administration in the telecommunication network 2102.

In the depicted example, the core network 2106 connects the network nodes 2110 to one or more hosts, such as host 2116. These connections may be direct or indirect via one or more intermediary networks or devices. In other examples, network nodes may be directly coupled to hosts. The core network 2106 includes one more core network nodes (e.g., core network node 2108) that are structured with hardware and software components. Features of these components may be substantially similar to those described with respect to the UEs, network nodes, and/or hosts, such that the descriptions thereof are generally applicable to the corresponding components of the core network node 2108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2116 may be under the ownership or control of a service provider other than an operator or provider of the access network 2104 and/or the telecommunication network 2102, and may be operated by the service provider or on behalf of the service provider. The host 2116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2100 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2102 is a cellular network that implements 3GPP standardized features. Accordingly, the telecommunications network 2102 may support network slicing to provide different logical networks to different devices that are connected to the telecommunication network 2102. For example, the telecommunications network 2102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2112 are configured to transmit and/or receive information without direct human interaction. For instance, a UE may be designed to transmit information to the access network 2104 on a predetermined schedule, when triggered by an internal or external event, or in response to requests from the access network 2104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2114 communicates with the access network 2104 to facilitate indirect communication between one or more UEs (e.g., UE 2112c and/or 2112d) and network nodes (e.g., network node 2110b). In some examples, the hub 2114 may be a controller, router, content source and analytics, or any of the other communication devices described herein regarding UEs. For example, the hub 2114 may be a broadband router enabling access to the core network 2106 for the UEs. As another example, the hub 2114 may be a controller that sends commands or instructions to one or more actuators in the UEs. Commands or instructions may be received from the UEs, network nodes 2110, or by executable code, script, process, or other instructions in the hub 2114. As another example, the hub 2114 may be a data collector that acts as temporary storage for UE data and, in some embodiments, may perform analysis or other processing of the data. As another example, the hub 2114 may be a content source. For example, for a UE that is a VR headset, display, loudspeaker or other media delivery device, the hub 2114 may retrieve VR assets, video, audio, or other media or data related to sensory information via a network node, which the hub 2114 then provides to the UE either directly, after performing local processing, and/or after adding additional local content. In still another example, the hub 2114 acts as a proxy server or orchestrator for the UEs, in particular in if one or more of the UEs are low energy IoT devices.

The hub 2114 may have a constant/persistent or intermittent connection to the network node 2110b. The hub 2114 may also allow for a different communication scheme and/or schedule between the hub 2114 and UEs (e.g., UE 2112c and/or 2112d), and between the hub 2114 and the core network 2106. In other examples, the hub 2114 is connected to the core network 2106 and/or one or more UEs via a wired connection. Moreover, the hub 2114 may be configured to connect to an M2M service provider over the access network 1104 and/or to another UE over a direct connection. In some scenarios, UEs may establish a wireless connection with the network nodes 2110 while still connected via the hub 2114 via a wired or wireless connection. In some embodiments, the hub 2114 may be a dedicated hub—that is, a hub whose primary function is to route communications to/from the UEs from/to the network node 2110b. In other embodiments, the hub 2114 may be a non-dedicated hub—that is, a device which is capable of operating to route communications between the UEs and network node 2110b, but which is additionally capable of operating as a communication start and/or end point for certain data channels.

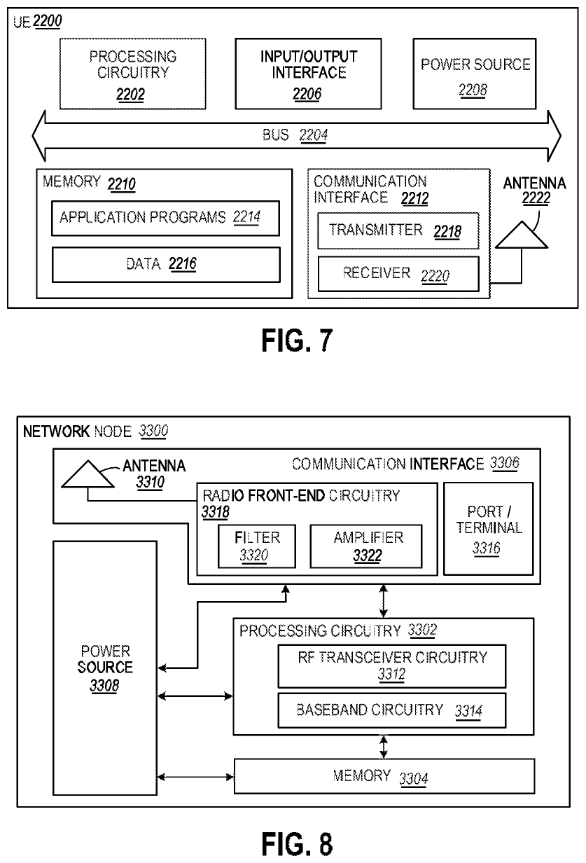

FIG. 7 shows a UE 2200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2200 includes processing circuitry 2202 that is operatively coupled via a bus 2204 to an input/output interface 2206, a power source 2208, a memory 2210, a communication interface 2212, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 2202 is configured to process instructions and data and may be configured to implement any sequential state machine operative to execute instructions stored as machine-readable computer programs in the memory 2210. The processing circuitry 2202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2202 may include multiple central processing units (CPUs).

In the example, the input/output interface 2206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2208 is structured as a battery or battery pack. Other types of power sources, such as an external power source (e.g., an electricity outlet), photovoltaic device, or power cell, may be used. The power source 2208 may further include power circuitry for delivering power from the power source 2208 itself, and/or an external power source, to the various parts of the UE 2200 via input circuitry or an interface such as an electrical power cable. Delivering power may be, for example, for charging of the power source 2208. Power circuitry may perform any formatting, converting, or other modification to the power from the power source 2208 to make the power suitable for the respective components of the UE 2200 to which power is supplied.

The memory 2210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2210 includes one or more application programs 2214, such as an operating system, web browser application, a widget, gadget engine, or other application, and corresponding data 2216. The memory 2210 may store, for use by the UE 2200, any of a variety of various operating systems or combinations of operating systems.

The memory 2210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2210 may allow the UE 2200 to access instructions, application programs and the like, stored on transitory or non-transitory memory media, to off-load data, or to upload data. An article of manufacture, such as one utilizing a communication system may be tangibly embodied as or in the memory 2210, which may be or comprise a device-readable storage medium.

The processing circuitry 2202 may be configured to communicate with an access network or other network using the communication interface 2212. The communication interface 2212 may comprise one or more communication subsystems and may include or be communicatively coupled to an antenna 2222. The communication interface 2212 may include one or more transceivers used to communicate, such as by communicating with one or more remote transceivers of another device capable of wireless communication (e.g., another UE or a network node in an access network). Each transceiver may include a transmitter 2218 and/or a receiver 2220 appropriate to provide network communications (e.g., optical, electrical, frequency allocations, and so forth). Moreover, the transmitter 2218 and receiver 2220 may be coupled to one or more antennas (e.g., antenna 2222) and may share circuit components, software or firmware, or alternatively be implemented separately.

In the illustrated embodiment, communication functions of the communication interface 2212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2200 shown in FIG. 7.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 8 shows a network node 3300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 3300 includes a processing circuitry 3302, a memory 3304, a communication interface 3306, and a power source 3308. The network node 3300 may be composed of multiple physically separate components (e.g., a NodeB component and a RNC component, or a BTS component and a BSC component, etc.), which may each have their own respective components. In certain scenarios in which the network node 3300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 3304 for different RATs) and some components may be reused (e.g., a same antenna 3310 may be shared by different RATs). The network node 3300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 3302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 3300 components, such as the memory 3304, to provide network node 3300 functionality.

In some embodiments, the processing circuitry 3302 includes a system on a chip (SOC). In some embodiments, the processing circuitry 3302 includes one or more of radio frequency (RF) transceiver circuitry 3312 and baseband processing circuitry 3314. In some embodiments, the radio frequency (RF) transceiver circuitry 3312 and the baseband processing circuitry 3314 may be on separate chips (or sets of chips), boards, or units, such as radio units and digital units. In alternative embodiments, part or all of RF transceiver circuitry 3312 and baseband processing circuitry 3314 may be on the same chip or set of chips, boards, or units.

The memory 3304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 3302. The memory 3304 may store any suitable instructions, data, or information, including a computer program, software, an application including one or more of logic, rules, code, tables, and/or other instructions capable of being executed by the processing circuitry 3302 and utilized by the network node 3300. The memory 3304 may be used to store any calculations made by the processing circuitry 3302 and/or any data received via the communication interface 3306. In some embodiments, the processing circuitry 3302 and memory 3304 is integrated.

The communication interface 3306 is used in wired or wireless communication of signaling and/or data between a network node, access network, and/or UE. As illustrated, the communication interface 3306 comprises port(s)/terminal(s) 3316 to send and receive data, for example to and from a network over a wired connection. The communication interface 3306 also includes radio front-end circuitry 3318 that may be coupled to, or in certain embodiments a part of, the antenna 3310. Radio front-end circuitry 3318 comprises filters 3320 and amplifiers 3322. The radio front-end circuitry 3318 may be connected to an antenna 3310 and processing circuitry 3302. The radio front-end circuitry may be configured to condition signals communicated between antenna 3310 and processing circuitry 3302. The radio front-end circuitry 3318 may receive digital data that is to be sent out to other network nodes or UEs via a wireless connection. The radio front-end circuitry 3318 may convert the digital data into a radio signal having the appropriate channel and bandwidth parameters using a combination of filters 3320 and/or amplifiers 3322. The radio signal may then be transmitted via the antenna 3310. Similarly, when receiving data, the antenna 3310 may collect radio signals which are then converted into digital data by the radio front-end circuitry 3318. The digital data may be passed to the processing circuitry 3302. In other embodiments, the communication interface may comprise different components and/or different combinations of components.

In certain alternative embodiments, the network node 3300 does not include separate radio front-end circuitry 3318, instead, the processing circuitry 3302 includes radio front-end circuitry and is connected to the antenna 3310. Similarly, in some embodiments, all or some of the RF transceiver circuitry 3312 is part of the communication interface 3306. In still other embodiments, the communication interface 3306 includes one or more ports or terminals 3316, the radio front-end circuitry 3318, and the RF transceiver circuitry 3312, as part of a radio unit (not shown), and the communication interface 3306 communicates with the baseband processing circuitry 3314, which is part of a digital unit (not shown).

The antenna 3310 may include one or more antennas, or antenna arrays, configured to send and/or receive wireless signals. The antenna 3310 may be coupled to the radio front-end circuitry 3318 and may be any type of antenna capable of transmitting and receiving data and/or signals wirelessly. In certain embodiments, the antenna 3310 is separate from the network node 3300 and connectable to the network node 3300 through an interface or port.

The antenna 3310, communication interface 3306, and/or the processing circuitry 3302 may be configured to perform any receiving operations and/or certain obtaining operations described herein as being performed by the network node. Any information, data and/or signals may be received from a UE, another network node and/or any other network equipment. Similarly, the antenna 3310, the communication interface 3306, and/or the processing circuitry 3302 may be configured to perform any transmitting operations described herein as being performed by the network node. Any information, data and/or signals may be transmitted to a UE, another network node and/or any other network equipment.

The power source 3308 provides power to the various components of network node 3300 in a form suitable for the respective components (e.g., at a voltage and current level needed for each respective component). The power source 3308 may further comprise, or be coupled to, power management circuitry to supply the components of the network node 3300 with power for performing the functionality described herein. For example, the network node 3300 may be connectable to an external power source (e.g., the power grid, an electricity outlet) via an input circuitry or interface such as an electrical cable, whereby the external power source supplies power to power circuitry of the power source 3308. As a further example, the power source 3308 may comprise a source of power in the form of a battery or battery pack which is connected to, or integrated in, power circuitry. The battery may provide backup power should the external power source fail.

Embodiments of the network node 3300 may include additional components beyond those shown in FIG. 8 for providing certain aspects of the network node's functionality, including any of the functionality described herein and/or any functionality necessary to support the subject matter described herein. For example, the network node 3300 may include user interface equipment to allow input of information into the network node 3300 and to allow output of information from the network node 3300. This may allow a user to perform diagnostic, maintenance, repair, and other administrative functions for the network node 3300.

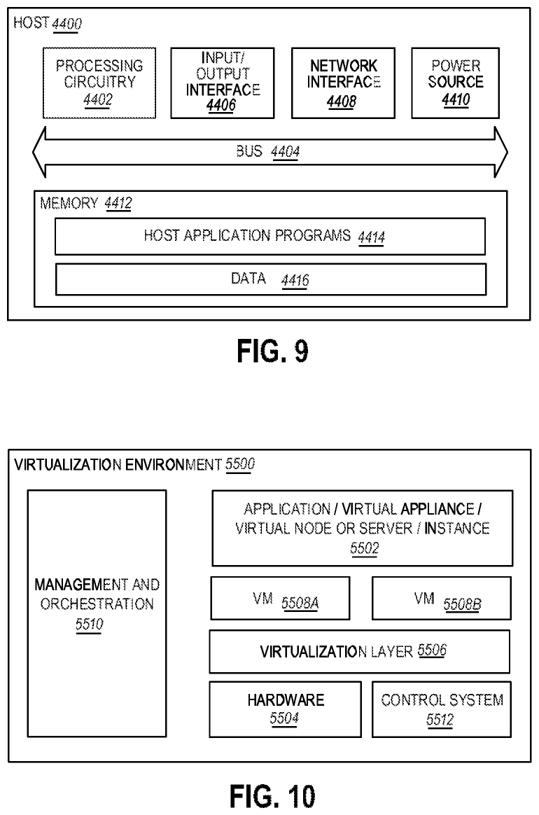

FIG. 9 is a block diagram of a host 4400, which may be an embodiment of the host 2116 of FIG. 6, in accordance with various aspects described herein. As used herein, the host 4400 may be or comprise various combinations hardware and/or software, including a standalone server, a blade server, a cloud-implemented server, a distributed server, a virtual machine, container, or processing resources in a server farm. The host 4400 may provide one or more services to one or more UEs.

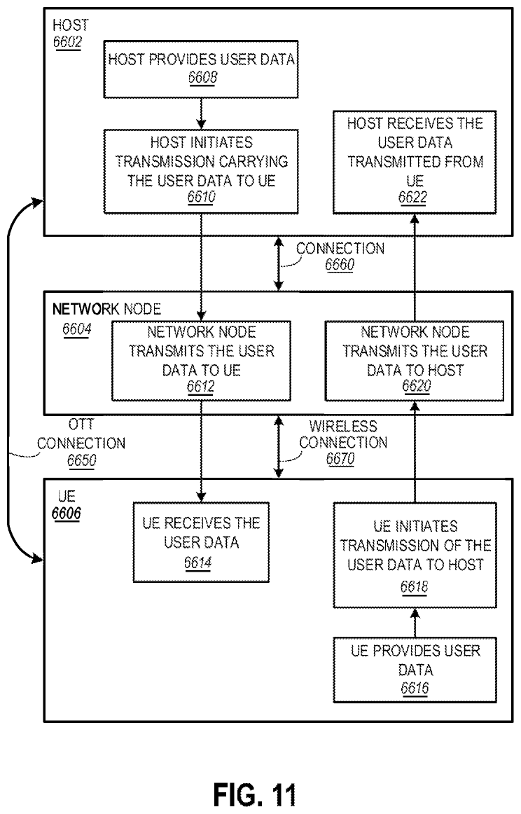

The host 4400 includes processing circuitry 4402 that is operatively coupled via a bus 4404 to an input/output interface 4406, a network interface 4408, a power source 4410, and a memory 4412. Other components may be included in other embodiments. Features of these components may be substantially similar to those described with respect to the devices of previous figures, such as FIGS. 10 and 11, such that the descriptions thereof are generally applicable to the corresponding components of host 4400.

The memory 4412 may include one or more computer programs including one or more host application programs 4414 and data 4416, which may include user data, e.g., data generated by a UE for the host 4400 or data generated by the host 4400 for a UE. Embodiments of the host 4400 may utilize only a subset or all of the components shown. The host application programs 4414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 4414 may also provide for user authentication and licensing checks and may periodically report health, routes, and content availability to a central node, such as a device in or on the edge of a core network. Accordingly, the host 4400 may select and/or indicate a different host for over-the-top services for a UE. The host application programs 4414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 10 is a block diagram illustrating a virtualization environment 5500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 5500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 5502 (which may alternatively be called software instances, virtual appliances, network functions, virtual nodes, virtual network functions, etc.) are run in the virtualization environment 5500 to implement some of the features, functions, and/or benefits of some of the embodiments disclosed herein.

Hardware 5504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 5506 (also referred to as hypervisors or virtual machine monitors (VMMs)), provide VMs 5508a and 5508b (one or more of which may be generally referred to as VMs 5508), and/or perform any of the functions, features and/or benefits described in relation with some embodiments described herein. The virtualization layer 5506 may present a virtual operating platform that appears like networking hardware to the VMs 5508.

The VMs 5508 comprise virtual processing, virtual memory, virtual networking or interface and virtual storage, and may be run by a corresponding virtualization layer 5506. Different embodiments of the instance of a virtual appliance 5502 may be implemented on one or more of VMs 5508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 5508 may be a software implementation of a physical machine that runs programs as if they were executing on a physical, non-virtualized machine. Each of the VMs 5508, and that part of hardware 5504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 5508 on top of the hardware 5504 and corresponds to the application 5502.

Hardware 5504 may be implemented in a standalone network node with generic or specific components. Hardware 5504 may implement some functions via virtualization. Alternatively, hardware 5504 may be part of a larger cluster of hardware (e.g., such as in a data center or CPE) where many hardware nodes work together and are managed via management and orchestration 5510, which, among others, oversees lifecycle management of applications 5502. In some embodiments, hardware 5504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 5512 which may alternatively be used for communication between hardware nodes and radio units.

FIG. 11 shows a communication diagram of a host 6602 communicating via a network node 6604 with a UE 6606 over a partially wireless connection in accordance with some embodiments. Example implementations, in accordance with various embodiments, of the UE (such as a UE 500, 790, 2112, and/or 2200), network node (such as network node 780, 2110, and/or 3300), and host (such as host 2116 of FIG. 6 and/or host 4400 of FIG. 9) discussed in the preceding paragraphs will now be described with reference to FIG. 11.

Like host 4400, embodiments of host 6602 include hardware, such as a communication interface, processing circuitry, and memory. The host 6602 also includes software, which is stored in or accessible by the host 6602 and executable by the processing circuitry. The software includes a host application that may be operable to provide a service to a remote user, such as the UE 6606 connecting via an over-the-top (OTT) connection 6650 extending between the UE 6606 and host 6602. In providing the service to the remote user, a host application may provide user data which is transmitted using the OTT connection 6650.

The network node 6604 includes hardware enabling it to communicate with the host 6602 and UE 6606. The connection 6660 may be direct or pass through a core network (like core network 2106 of FIG. 6) and/or one or more other intermediate networks, such as one or more public, private, or hosted networks. For example, an intermediate network may be a backbone network or the Internet.

The UE 6606 includes hardware and software, which is stored in or accessible by UE 6606 and executable by the UE's processing circuitry. The software includes a client application, such as a web browser or operator-specific “app” that may be operable to provide a service to a human or non-human user via UE 6606 with the support of the host 6602. In the host 6602, an executing host application may communicate with the executing client application via the OTT connection 6650 terminating at the UE 6606 and host 6602. In providing the service to the user, the UE's client application may receive request data from the host's host application and provide user data in response to the request data. The OTT connection 6650 may transfer both the request data and the user data. The UE's client application may interact with the user to generate the user data that it provides to the host application through the OTT connection 6650.

The OTT connection 6650 may extend via a connection 6660 between the host 6602 and the network node 6604 and via a wireless connection 6670 between the network node 6604 and the UE 6606 to provide the connection between the host 6602 and the UE 6606. The connection 6660 and wireless connection 6670, over which the OTT connection 6650 may be provided, have been drawn abstractly to illustrate the communication between the host 6602 and the UE 1606 via the network node 6604, without explicit reference to any intermediary devices and the precise routing of messages via these devices.

As an example of transmitting data via the OTT connection 6650, in step 6608, the host 6602 provides user data, which may be performed by executing a host application. In some embodiments, the user data is associated with a particular human user interacting with the UE 6606. In other embodiments, the user data is associated with a UE 6606 that shares data with the host 6602 without explicit human interaction. In step 6610, the host 6602 initiates a transmission carrying the user data towards the UE 6606. The host 6602 may initiate the transmission responsive to a request transmitted by the UE 6606. The request may be caused by human interaction with the UE 6606 or by operation of the client application executing on the UE 6606. The transmission may pass via the network node 6604, in accordance with the teachings of the embodiments described throughout this disclosure. Accordingly, in step 6612, the network node 6604 transmits to the UE 6606 the user data that was carried in the transmission that the host 6602 initiated, in accordance with the teachings of the embodiments described throughout this disclosure. In step 6614, the UE 6606 receives the user data carried in the transmission, which may be performed by a client application executed on the UE 6606 associated with the host application executed by the host 6602.

In some examples, the UE 6606 executes a client application which provides user data to the host 6602. The user data may be provided in reaction or response to the data received from the host 6602. Accordingly, in step 6616, the UE 6606 may provide user data, which may be performed by executing the client application. In providing the user data, the client application may further consider user input received from the user via an input/output interface of the UE 6606. Regardless of the specific manner in which the user data was provided, the UE 6606 initiates, in step 6618, transmission of the user data towards the host 6602 via the network node 6604. In step 6620, in accordance with the teachings of the embodiments described throughout this disclosure, the network node 6604 receives user data from the UE 6606 and initiates transmission of the received user data towards the host 6602. In step 6622, the host 6602 receives the user data carried in the transmission initiated by the UE 6606.

One or more of the various embodiments improve the performance of OTT services provided to the UE 6606 using the OTT connection 6650, in which the wireless connection 6670 forms the last segment. More precisely, the teachings of these embodiments may improve the data rate, latency, and/or power consumption and thereby provide benefits such as reduced user waiting time, relaxed restriction on file size, improved content resolution, better responsiveness, and/or extended battery lifetime.

In an example scenario, factory status information may be collected and analyzed by the host 6602. As another example, the host 6602 may process audio and video data which may have been retrieved from a UE for use in creating maps. As another example, the host 6602 may collect and analyze real-time data to assist in controlling vehicle congestion (e.g., controlling traffic lights). As another example, the host 6602 may store surveillance video uploaded by a UE. As another example, the host 6602 may store or control access to media content such as video, audio, VR or AR which it can broadcast, multicast or unicast to UEs. As other examples, the host 6602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 6650 between the host 6602 and UE 6606, in response to variations in the measurement results. The measurement procedure and/or the network functionality for reconfiguring the OTT connection may be implemented in software and hardware of the host 6602 and/or UE 6606. In some embodiments, sensors (not shown) may be deployed in or in association with other devices through which the OTT connection 6650 passes; the sensors may participate in the measurement procedure by supplying values of the monitored quantities exemplified above, or supplying values of other physical quantities from which software may compute or estimate the monitored quantities. The reconfiguring of the OTT connection 6650 may include message format, retransmission settings, preferred routing etc.; the reconfiguring need not directly alter the operation of the network node 6604. Such procedures and functionalities may be known and practiced in the art. In certain embodiments, measurements may involve proprietary UE signaling that facilitates measurements of throughput, propagation times, latency and the like, by the host 6602. The measurements may be implemented in that software causes messages to be transmitted, in particular empty or ‘dummy’ messages, using the OTT connection 6650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

It will be appreciated that computer systems are increasingly taking a wide variety of forms. In this description and in the claims, the terms “controller,” “computer system,” or “computing system” are defined broadly as including any device or system—or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The memory may take any form and may depend on the nature and form of the computing system. The memory can be physical system memory, which includes volatile memory, non-volatile memory, or some combination of the two. The term “memory” may also be used herein to refer to non-volatile mass storage such as physical storage media.

The computing system also has thereon multiple structures often referred to as an “executable component.” For instance, the memory of a computing system can include an executable component. The term “executable component” is the name for a structure that is well understood to one of ordinary skill in the art in the field of computing as being a structure that can be software, hardware, or a combination thereof.

For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it is operable, when executed by one or more processors of the computing system, to cause the computing system to perform one or more functions, such as the functions and methods described herein. Such a structure may be computer-readable directly by a processor—as is the case if the executable component were binary. Alternatively, the structure may be structured to be interpretable and/or compiled—whether in a single stage or in multiple stages—so as to generate such binary that is directly interpretable by a processor.

The term “executable component” is also well understood by one of ordinary skill as including structures that are implemented exclusively or near-exclusively in hardware logic components, such as within a field programmable gate array (FPGA), an application specific integrated circuit (ASIC), Program-specific Standard Products (ASSPs), System-on-a-chip systems (SOCs), Complex Programmable Logic Devices (CPLDs), or any other specialized circuit. Accordingly, the term “executable component” is a term for a structure that is well understood by those of ordinary skill in the art of computing, whether implemented in software, hardware, or a combination thereof.

The terms “component,” “service,” “engine,” “module,” “control,” “generator,” or the like may also be used in this description. As used in this description and in this case, these terms—whether expressed with or without a modifying clause—are also intended to be synonymous with the term “executable component” and thus also have a structure that is well understood by those of ordinary skill in the art of computing.

In an embodiment, the communication system may include a complex of computing devices executing any of the method of the embodiments as described above and data storage devices which could be server parks and data centers.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In general, the various exemplary embodiments may be implemented in hardware or special purpose chips, circuits, software, logic, or any combination thereof. For example, some aspects may be implemented in hardware, while other aspects may be implemented in firmware or software which may be executed by a controller, microprocessor, or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

While not all computing systems require a user interface, in some embodiments a computing system includes a user interface for use in communicating information from/to a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

Accordingly, embodiments described herein may comprise or utilize a special purpose or general-purpose computing system. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example—not limitation—embodiments disclosed or envisioned herein can comprise at least two distinctly different kinds of computer-readable media: storage media and transmission media.

Computer-readable storage media include RAM, ROM, EEPROM, solid state drives (“SSDs”), flash memory, phase-change memory (“PCM”), CD-ROM or other optical disk storage, magnetic disk storage or other magnetic storage devices, or any other physical and tangible storage medium that can be used to store desired program code in the form of computer-executable instructions or data structures and that can be accessed and executed by a general purpose or special purpose computing system to implement the disclosed functionality or functionalities. For example, computer-executable instructions may be embodied on one or more computer-readable storage media to form a computer program product.

Transmission media can include a network and/or data links that can be used to carry desired program code in the form of computer-executable instructions or data structures and that can be accessed and executed by a general purpose or special purpose computing system. Combinations of the above should also be included within the scope of computer-readable media.

Further, upon reaching various computing system components, program code in the form of computer-executable instructions or data structures can be transferred automatically from transmission media to storage media (or vice versa). For example, computer-executable instructions or data structures received over a network or data link can be buffered in RAM within a network interface module (e.g., a “NIC”) and then eventually transferred to computing system RAM and/or to less volatile storage media at a computing system. Thus, it should be understood that storage media can be included in computing system components that also—or even primarily—utilize transmission media.

Those skilled in the art will further appreciate that a computing system may also contain communication channels that allow the computing system to communicate with other computing systems over, for example, a network. Accordingly, the methods described herein may be practiced in network computing environments with many types of computing systems and computing system configurations. The disclosed methods may also be practiced in distributed system environments where local and/or remote computing systems, which are linked through a network (either by wired data links, wireless data links, or by a combination of wired and wireless data links), both perform tasks. In a distributed system environment, the processing, memory, and/or storage capability may be distributed as well.

Those skilled in the art will also appreciate that the disclosed methods may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

### Abbreviations and Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or embodiments includes a specific reference to one or more embodiments thereof, and vice versa, and is intended to provide illustrative examples without limiting the scope of the present disclosure, which is indicated by the appended claims rather than by the present description.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### CONCLUSION

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by certain embodiments, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described embodiments are examples only. Alterations, modifications, and variations may be effected to the particular embodiments by those of skill in the art without departing from the scope of the description, which is defined solely by the appended claims.

1. A method performed by a user equipment (UE), for resolving a performance problem in a machine learning model, the method comprising:
detecting one or more performance problems in the machine learning model performed by the UE; and
in response to the detecting, performing one or more resolutions actions.

2. The method of claim 1, further comprising receiving a configuration from a network node, the configuration comprising one or more parameters for at least one of:
monitoring performance in the machine learning model;
detecting a performance problem in the machine learning model; and
performing one or more resolution actions.

3. The method of claim 1, further comprising monitoring performance in the machine learning model performed by the UE.

4. The method of claim 3, wherein the monitoring comprises generating one or more metrics related to an error or accuracy of the machine learning model.

5. The method of claim 4, wherein the one or more metrics measure at least one of: an error calculated based on one or more outputs of the machine learning model and a corresponding parameter the machine learning model is configured to estimate and/or predict; an absolute or relative error; an accuracy calculated based on one or more outputs of the machine learning model and a corresponding parameter the machine learning model is configured to estimate and/or predict; an absolute or relative accuracy; a value in percentage that indicates a confidence level of an outcome of the machine learning model; a representation of a distribution that indicates a confidence level of an outcome of the machine learning model; a representation of a confidence interval; one or more statistics of data collected within a time window related to the machine learning model; one or more key performance indicators indicating an ability, quality, power or accuracy of the machine learning model to estimate a parameter in comparison to an actual value of the parameter.

6. The method of claim 4, wherein the one or more metrics are configured by a network node.

7. (canceled)

8. The method of claim 4, wherein the one or more metrics are associated with a capability which the UE reports to a network node.

9-10. (canceled)

11. The method of claim 4, wherein the one or more metrics are compared to a reference value of the one or more metrics associated to a performance indicator of a feature associated to the machine learning model.

12. The method of claim 11, wherein the performance indicator of the feature associated to the machine learning model has its own reference value associated to an acceptable level of the performance indicator of the feature associated to the machine learning model.

13. The method of claim 3, wherein the UE starts monitoring the performance of the machine learning model when the UE transitions to Radio Resource Control Connected, RRC_CONNECTED.

14. The method of claim 13, wherein the UE monitors performance of the machine learning model while the UE is in RRC_CONNECTED, and wherein the UE stops monitoring the performance of the machine learning model when the UE transitions to Radio Resource Control Idle, RRC_IDLE, upon reception of an RRC Release message or when the UE transitions to Radio Resource Control Inactive, RRC_INACTIVE, upon reception of an RRC Release message with a suspend configuration.

15-18. (canceled)

19. The method of claim 3, wherein the UE performs the monitoring periodically according to an assessment period, wherein the assessment period is configured by a network to the UE or the assessment period is derived by the UE based on one or more parameters.

20-23. (canceled)

24. The method of claim 19, wherein the monitoring periodically is based on one or more parameters.

25. The method of claim 24, wherein the one or more parameters comprise one or more of: the machine learning model or features of the machine learning model to monitor; whether to monitor performance across multiple serving cells or only within a current serving cell; a time window for the monitoring; if the monitoring is to be stopped or suspended by the UE when the UE transitions to RRC IDLE and/or RRC INACTIVE state from RRC_CONNECTED state; if the monitoring is to be maintained by the UE when the UE transitions to RRC_CONNECTED; if the monitoring is performed both in discontinuous reception and non-discontinuous reception operation by the UE; if the monitoring is stopped when uplink, UL, timing alignment is lost; if the monitoring is stopped when the UE has lost UL synchronization; if the monitoring is stopped by the expiry of a timeAlignmentTimer; if the monitoring is stopped and then continues if an event is triggered; if the monitoring is stopped and the UE will try to achieve UL synchronization and, subsequently, transmit the associated report; information about a periodicity and/or time domain offset based on which the UE derives which time domain resources are allowed to be used for monitoring the performance of the machine learning model.

26. (canceled)

27. The method of claim 23, wherein the UE performs the monitoring aperiodically.

28. (canceled)

29. The method of claim 27, further comprising receiving a request from a network to perform aperiodic monitoring.

30. (canceled)

31. The method of claim 27, wherein the aperiodic monitoring is based on one or more parameters.

32. The method of claim 31, wherein the one or more parameters comprise one or more of: the machine learning model or features of the machine learning model to monitor; whether to monitor performance across multiple serving cells or only within a current serving cell; a time window for the monitoring; if the monitoring is to be stopped or suspended by the UE when the UE transitions to RRC IDLE and/or RRC INACTIVE state from RRC_CONNECTED state; if the monitoring is to be maintained by the UE when the UE transitions to RRC_CONNECTED; if the monitoring is performed both in discontinuous reception and non-discontinuous reception operation by the UE; if the monitoring is stopped when uplink, UL, timing alignment is lost; if the monitoring is stopped when the UE has lost UL synchronization; if the monitoring is stopped by the expiry of a timeAlignmentTimer; if the monitoring is stopped and then continues if an event is triggered; if the monitoring is stopped and the UE will try to achieve UL synchronization and, subsequently, transmit the associated report; information about a periodicity and/or time domain offset based on which the UE derives which time domain resources are allowed to be used for monitoring the performance of the machine learning model.

33. The method of claim 27, wherein the configuration of the aperiodic monitoring is done by one or more of: RRC; Medium Access Control Control Element, MAC CE; layer one, L1, signalling; Downlink Control Information, DCI, format.

34-44. (canceled)

45. The method of claim 1, wherein if the UE detects a performance problem then the UE increments a failure counter, and if the number of performance problems reaches a determined maximum number for the failure counter, then a failure timer is started; and
while the failure timer is running the UE counts a number of times that performance of the machine learning model becomes better than an unacceptable level; and
if the counter number of times that performance of the machine learning model becomes better than an unacceptable level reaches a predetermined number, then the UE stops the failure timer and resets the failure counter.

46-52. (canceled)

53. The method of claim 1, wherein the one or more resolution actions comprises the UE performing training or re-training of the machine learning model.

54-61. (canceled)

62. The method of claim 1, wherein the one or more resolution actions comprises:
the UE resetting the machine learning model;
deleting one or more outputs of the machine learning model;
stopping one or more ongoing processes that use one or more outputs of the machine learning model; and
the UE resetting at least one protocol layer or protocol entity where the machine learning model is being used.

63-70. (canceled)

71. A method performed by a network node for configuring a user equipment (UE) to monitor a machine learning model, the method comprising:
transmitting to the UE a configuration indicating the UE to perform detection of a performance problem in a machine learning model and to perform one or more resolution actions.

72-73. (canceled)

74. A user equipment (UE), for monitoring, detecting problems, or resolving performance in a machine learning model, comprising:
processing circuitry configured to perform operations comprising:
detecting one or more performance problems in the machine learning model performed by the UE; and
in response to the detecting, performing one or more resolutions actions; and
power supply circuitry configured to supply power to the processing circuitry.

75. A network node for configuring a user equipment (UE) for monitoring, detecting problems, or resolving performance in a machine learning model, the network node comprising:
processing circuitry configured to perform operations comprising:
transmitting to the UE a configuration indicating that the UE is to perform one or more resolution actions; and
power supply circuitry configured to supply power to the processing circuitry.

76. (canceled)
